(19) United States
(12) Patent Application Publication
(10) Pub. No.: US 2014/0279635 A1
(43) Pub. Date: Sep. 18, 2014

(54) SYSTEM AND METHOD FOR UTILIZING ASSESSMENTS

(71) Applicant: PROFILES INTERNATIONAL, INC., Waco, TX (US)

(72) Inventors: William L. Bramlett, JR., Tolar, TX (US); Scott Hamilton, China Spring, TX (US); Joseph M. Kistner, Waco, TX (US)

(73) Assignee: PROFILES INTERNATIONAL, INC., Waco, TX (US)

(21) Appl. No.: 14/196,303

(22) Filed: Mar. 4, 2014

Related U.S. Application Data
(60) Provisional application No. 61/779,811, filed on Mar. 13, 2013.

(51) Int. Cl. G06Q 10/10

(52) U.S. Cl. CPC G06Q 10/1053
USPC 705/321

(57) ABSTRACT

A system maintains job performance data for a plurality of persons employed in a plurality of occupations and maintains assessment data for the plurality of persons. Top performers in each of the plurality of occupations are identified as a function of the job performance data. The system receives assessment data for an individual person. The system compares the assessment data for the individual person with the assessment data for the top performers in each of the plurality of occupations. The system recommends one or more of the plurality of occupations to the individual person as a function of the comparison, such that the individual person is more likely to succeed in the one or more of the recommended occupations.

### RELATED APPLICATIONS

This application claims the benefit of and priority to U.S. Provisional Application No. 61/779,811, filed on Mar. 13, 2013, entitled “System And Method For Utilizing Assessments To Provide Occupational Guidance,” which is hereby incorporated by reference in its entirety for all purposes. The present disclosure is related to U.S. patent application Ser. No. 13/107,176, entitled “System For Selecting Employment Candidates,” which was filed on May 13, 2011, and which is hereby incorporated by reference in its entirety for all purposes.

### TECHNICAL FIELD

The present disclosure relates to a system and method for utilizing assessments to provide occupational guidance to students, employees, and potential employees.

### BACKGROUND

People in general desire to succeed in a career that interests them, is rewarding, and provides attractive compensation. Business organizations have similar interests, in that they would like to hire talented, qualified, and hardworking persons, and compensate them fairly and competitively so that they can retain these valuable personnel assets. Historically, a person has chosen a career based mainly, if not solely, on what interests the person. Along these lines, there exist in the market today career guidance products, however, such products are reliant only on a measure of the person's interests to suggest occupation or career choices.

Similarly, a business organization that has to select among a pool of candidates to fill job openings is in an unenviable position. Specifically, it is very difficult in the typical and rather short evaluation process to identify the candidates that will truly have the best potential for success in a particular job position or occupation. Indeed, such employment and career decisions are normally based only on academic transcripts, a resume, a written recommendation or two, and a relatively short in-person interview.

Additionally, current systems that attempt to assist in the employee selection process tend to focus only on one definition of a potentially successful candidate. Such systems have difficulty identifying outliers, that is, candidates who are not identified according to the system's standards, but nevertheless would make a potentially successful candidate. Moreover, attempts to broaden the standards or lower the threshold, in an attempt to capture these outliers, seem to identify candidates as potentially successful when they simply are not.

The art is therefore in need of one or more systems to address these issues. Specifically, the art is in need of a system for providing guidance to persons (e.g., students completing high school, students entering secondary education, workers seeking a career change, or unemployed workers seeking to reenter the workforce) so that they can focus on occupational areas for which they are best suited. Additionally, business organizations would benefit from a system that can more accurately and effectively identify persons who would excel in a particular job or a particular occupation.

### BRIEF DESCRIPTION OF THE DRAWINGS

FIG. 1 is a block diagram illustrating a system for using assessments to provide career and occupational guidance to persons.

FIG. 2 is a flowchart of an example process of using assessments to provide career and occupational guidance to persons.

FIGS. 3A and 3B are a flowchart of another example process of using assessments to provide career and occupational guidance to persons.

FIGS. 4A and 4B are a flowchart of another example embodiment of a process to identify a candidate for a particular occupation.

FIGS. 5A and 5B are a flowchart of another example embodiment of a process to identify a candidate for a particular occupation.

FIG. 6 is an example embodiment of an output of a performance model generated by a neural network.

FIGS. 7 and 7A are example embodiments of scores for a candidate.

FIG. 8 is an example embodiment of an output of a particular candidate and scores for that candidate for several occupations.

FIG. 9 is an example embodiment of an output comparing a candidate to other candidates.

FIG. 10 is an example embodiment of a computer system upon which one or more embodiments of the present disclosure can execute.

### DETAILED DESCRIPTION

An embodiment relates to the use of assessments to provide direction toward careers and occupations in which an individual candidate will most likely succeed. Characteristics of the individual are determined by completion of an assessment of multiple constructs, providing an overall view of the individual. The assessment can be online and/or Internet-based. The multiple constructs provide, at a minimum, feedback on the individual's verbal and math skills (cognitive), behavioral characteristics, and personal interests. Each construct value is matched to a database of benchmark patterns established for a multitude of careers/jobs using a multitude of persons employed in those careers/jobs. That is, the benchmark data are based on actual data gathered from years of employment assessments of persons actually employed in the multitude of careers and jobs. These occupations/jobs may include careers/jobs from an established database while additionally including newer job categories not yet represented by the established database.

As noted above, typical career guidance products today are reliant only on a measure of the individual's interests to suggest occupation choices. Research suggests that using only a person's interests is a poor predictor of success in a job or career. However, by utilizing an assessment that provides insight into an individual's specific numeric and verbal skill levels (i.e., cognitive abilities), behavioral characteristics, and highest areas of interest, a much higher correlation to success in a job or career for which a “match” is found can be achieved. The systems and methods disclosed herein provide such matching and a resultant ranked list of the occupations/jobs for which the individual candidate is most suited.

FIG. 1 is a block diagram of such a system with two alternative reports. An assessment is begun at 100, wherein scores 110 are generated for an individual. At 130, the scores 110 for the individual are compared with scores 120 of successful incumbents. Two reports can be generated from the comparison 130. The first report 140 is a ranked list of all occupations with the top-listed occupations being the best match for the individual candidate. The second alternative report 150 is once again a ranked list of occupations, but they are categorized into job clusters or groupings that align with cluster definitions in the database of historical data of the multitude of persons in the multitude of occupations. The clusters of interest selected by the candidate will be those included in the ranked report.

In an embodiment, each job or occupation represented in the database of a multitude of jobs and occupations has a single benchmark pattern of the assessed constructs for which a candidate is matched. Another embodiment includes the use of a neural network to evaluate the abundance of available industry data for each type of job or career to determine if there could be more than one representative benchmark to indicate high performance in a given job or career. This other embodiment matches the individual candidate to the one or more patterns for each of the multitude of jobs or occupations to determine the level of match, and therefore the likelihood of success.

Consequently, in an embodiment, a computer system delivers to an assessment taker (i.e., a candidate) a list of questions designed to gather information about the candidate's abilities and characteristics in a range of categories that include, but that are not limited to, cognitive abilities and characteristics, behavioral abilities and characteristics, and interests. As part of the setup for delivery of the assessment, the computer system stores the candidate's responses to key questions about where they are in their career process such as education level completed, additional education planned, and a particular type of job or career for which the person has a particular interest. These types of jobs or careers can be chosen from job clusters in the database that have been constructed over the years by collecting data from a multitude of people in a multitude of careers.

The person provides responses to assessment questions. The computer system “scores” the responses resulting in a pattern representing the candidate's characteristics measured on the multiple constructs covered by the assessment. The computer system matches the candidate's scores or pattern to scores or patterns in a database representing a broad range of careers and jobs. The computer system generates a report with a ranked list of career/job matches for which the candidate is most likely to succeed. In an embodiment, a software-implemented neural network is used to suggest construct values or patterns representing successful workers or top performers in a job or occupation. The neural network provides one or more patterns per job or occupation. In short, the computer system can match the candidate's scores or pattern to scores or patterns in a database representing a broad range of careers/jobs.

As noted above, a software-implemented neural network can be used to generate patterns indicating the characteristics of top performers in a plurality of jobs and occupations. The neural network can also be used to generate scores or patterns for individuals based on the individual's responses to a set of questions. The neural network can then compare the individual's patterns with the population's patterns for a particular job or occupation to see if that individual matches the pattern of the population (usually the top performers in that occupation).

By way of background, biological neural networks are made up of neurons that are connected or functionally related in the peripheral nervous system or the central nervous system. In the field of neuroscience, neural networks are often identified as groups of neurons that perform a specific physiological function.

Artificial neural networks are made up of interconnecting artificial neurons, that is, programming constructs that mimic the properties of biological neurons. Artificial neural networks can be used to gain an understanding of biological neural networks, or for solving artificial intelligence problems without necessarily creating a model of a real biological system. The tasks to which artificial neural networks are applied tend to fall into the following categories. A first category includes function approximation, or regression analysis, including time series predicting and modeling. A second category includes classification, including pattern and sequence recognition, novelty detection, and sequential decision making. A third category includes data processing, including filtering, clustering, and blind signal separation and compression. The third category can further include system identification and control (vehicle control, process control), pattern recognition (radar systems, face identification, and object identification), sequence recognition (gesture, speech, handwritten text), medical diagnoses, financial applications, data mining, visualization, email spam filtering, and game playing and decision making.

An artificial neural network is trained to recognize multiple patterns that may be desirable, and distinguish these desirable patterns from other patterns that are not desirable. It is this technique of artificial neural networks that can be applied to one or more embodiments that identify a potentially successful candidate for a particular profession. Such artificial neural networks can be obtained from software companies that specialize in the design and implementation of such neural networks. Such companies normally can design and construct a customized neural network based on the needs of a particular customer, or modify and adapt a basic neural network to the needs of such a customer. For example, two such neural network providers are NeuralWare of Carnegie, Pa., and StatSoft of Tulsa, Okla.

FIGS. 2, 3A, 3B, 4A, 4B, 5A, and 5B are flowcharts of example processes 200, 300, 400, and 500 for using a neural network to provide occupational guidance and/or to select employees for a particular job or occupation. The processes 200 and 300 can identify the occupations out of a plurality of occupations that are most suitable to an individual, and the processes 400 and 500 can identify the candidates who are most likely to be the top performers in a particular job. In the one embodiment, this identification is accomplished by using the neural network to model the personal and performance traits of known top performers in a plurality of occupations, and comparing an individual to the model. In another embodiment, this identification is accomplished by using the neural network to model the personal and performance traits of known top performers in a particular type of job, and comparing a candidate for that particular job to the model. FIGS. 2, 3A, 3B, 4A, 4B, 5A, and 5B include a number of process blocks 205-260, 305-357, 405-480, and 505-590 respectively. Though arranged serially in the example of FIGS. 2A, 2B, 3A, 3B, 4A, 4B, 5A, and 5B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

### Career Guidance Using Assessments

### Example No. 1

Referring now specifically to FIG. 2, at 205, a database of job performance data for a plurality of persons employed in a plurality of occupations is maintained in a computer storage device. At 210, assessment data is maintained in the database for the plurality of persons. The assessment data includes cognitive assessment data, personal and/or behavioral assessment data, and personal interest assessment data. At 215, top performers in each of the plurality of occupations are identified as a function of the job performance data. At 220, cognitive assessment data, personal assessment data, and interest assessment data are collected from an individual. At 225, the cognitive assessment data, personal assessment data, and interest assessment data for the individual person are compared with the cognitive assessment data, personal assessment data, and interest assessment data for the top performers in each of the plurality of occupations. At 230, one or more occupations are recommended for the individual person as a function of the comparison of the cognitive assessment data, personal assessment data, and interest assessment data of the individual person with the cognitive assessment data, personal assessment data, and interest assessment data of the top performers in each of the plurality of occupations. This comparison identifies the occupations out of the plurality of occupations wherein the individual person is more likely to succeed.

At 235, the cognitive data, personal data, and interest data of the plurality of persons are determined from responses by the plurality of persons to assessment questions. Such a question may be for example, “True or False”, “It annoys me when there are more that three people waiting in line in a store and the store manager does not open up another checkout line.” If a person answers “No”, then the person is probably a patient person (personal/behavioral data). Then, as will be discussed herein, if the top performers in a particular occupation tend to be patient people (as measured by their answers to the same or similar assessment questions), then the individual is more likely to be successful in this particular occupation. In a similar fashion, at 240, the cognitive data, personal data, and interest data of the individual person are determined from responses by the individual person to assessment questions.

At 245, the assessment data for the plurality of persons are collected over a period of years. This collection of data over a period of years generates a substantial database of a multitude of persons in a multitude of occupations. The vast amount of data provides for a more accurate and reliable assessment of career options for an individual. At 250, a new occupation is added to the plurality of occupations. For example, the occupation of Life Coach could be added to the database, and assessment data for persons employed as a Life Coach and the identification of top performers in the Life Coach occupation could also be added to the database. At 255, the recommendation of the one or more occupations includes a ranked list of occupations ranging from occupations that are most suited to the individual person to occupations that are least suited to the individual person. At 260, the system collects data relating to the individual person including the highest education level that the individual person completed, additional education planned, by the individual person, and an indicated interest in one or more occupations by the individual person. This data relating to the educational level completed, additional education planned, and the indicated interest in one or more occupations is used in making the recommendation of the one or more occupations to the individual person.

### Career Guidance Using Assessments

### Example No. 2

Referring to FIGS. 3A and 3B, at 305, data is received into a computer processor of a career guidance assessment system. The data relates to a plurality of persons in a plurality of occupations. A portion of the plurality of persons includes top performers in the occupations. The data relates to one or more of cognitive traits, personal traits, interest traits, and performance traits. At 310, these cognitive trait, personal trait, interest trait, and performance trait data are input into a software-based neural network.

At 315, the neural network is used to generate models. The generation of these models includes, for each of the occupations, models relating to the personal traits as a function of the personal traits and the performance traits of the top performers, models relating to the cognitive traits as a function of the cognitive traits and performance traits of the top performers, and models relating to the interest traits as a function of the interest traits and performance traits of the top performers. At 320, the neural network is used to generate a performance model for each of the occupations. The performance model for each of the occupations includes one or more of the personal traits models, the cognitive traits models, and the interest traits models (of the top performers in the particular occupation). At 325, the performance models are configured to determine that a particular person, who is not one of the plurality of persons, will likely be a top performer in one or more of the occupations.

At 330, the computer processor in the career guidance assessment system is configured to receive data relating to the particular person. The data relates to one or more of the personal traits, the cognitive traits, and the interest traits of the particular person. As noted above, this data is determined by providing a set of questions to the particular person. The responses to these questions are then used to determine aspects of the particular person, such as whether the particular person is more math-minded or more verbal-minded, whether the person is more assertive or more passive, and whether the person is more interested in business or science. In an embodiment, the questions are substantially similar to the questions that were provided to the plurality of persons in the plurality of occupations and used in the generation of the performance models in each of the plurality of occupations (based on the top performers in each of the occupations). At 331, the career guidance assessment system compares the data relating to the particular person (cognitive, behavior, and interest models) to the performance models of the plurality of occupations. At 332, an assessment of whether the particular person is likely to be rated as a top performer in each of the plurality of occupations is generated based on the comparisons.

At 333, the data relating to the particular person and the data relating to the plurality of persons in the plurality of occupations are obtained from answers provided by the particular person and the plurality of persons in the plurality of occupations to a set of questions that are independent of the models (cognitive, behavior, and interest models for the particular person), the performance models based on the plurality of models in the plurality of occupations, and the plurality of occupations. In other words, the same questions, or substantially the same questions, are used in all assessment situations. This provides a validity and accuracy to the system. At 334, the career guidance assessment system generates a display on an output device. The display includes data relating to the assessment of the particular person. The display can further comprise one or more of a ranking of the plurality of occupations for which the particular person is most suited, a ranking relating to the particular person and cognitive traits for each of the plurality of occupations, a ranking relating to the particular person and interest traits for each of the plurality of occupations, and a ranking relating to the particular person and behavioral traits for each of the plurality of occupations. For example, the system may report that the particular person, when compared to the plurality of persons in the plurality of occupations, ranks at 80% based on the performance models of the persons in the accounting field, and at 60% based on the performance models in the medical field. In an embodiment, this percentage is calculated by determining the ratio of the cognitive, behavior, and interest models that the particular person falls into in the performance model for the particular occupation.

At 335, the personal traits models (i.e., cognitive, behavioral, and interest) include a numeric range. At 336, the neural network generates for each of the plurality of occupations at least one personal (behavioral) traits model, cognitive traits model, or interest traits model that includes two or more numeric sub-ranges within the numeric range of the at least one personal (behavioral) traits model, cognitive traits model, or interest traits model such that the system is less likely to treat the particular person as an outlier candidate. As noted above, an outlier candidate may be a person who falls outside of the performance model for a particular occupation, but still may be likely to be a successful performer in that occupation. More specifically, in such systems, there are thousands or even millions of records having data relating to individuals in all occupations. In an embodiment, the system searches for a most prominent pattern or model for a given occupation. However, there may be successful incumbents that exhibit a different model, which should be included. So, these successful incumbents that exhibit a different model are not considered an outlier in the occupation or performance area per se, but only an outlier in that they don't match the most prominent model. Once again, by including models other than the most prominent model, such individuals are less likely to be missed. At 337, the neural network determines a breadth of a particular model, and at 338, the neural network determines a weight to be accorded to a particular model.

At 340, the neural network generates a plurality of performance models for each of the plurality of occupations. Each performance model from the plurality of occupations is configured to identify the particular person as a potential top performer in each respective occupation. Of course, if the particular person is not identified as a potential top performer in a particular occupation, then it can be assumed that that person would likely be an average performer or a bottom performer in that occupation. At 345, the neural network nulls out a particular model to determine the effect of the nulling out on other models. For example, the neural network can null out one of the behavioral models, such as patience, to see if it has any effect on the other models, the performance model as a whole, or the assessment of the particular person. At 350, the performance traits can include such things as a sales quota, an error rate, a production level, and a level of customer complaints. At 355, and as noted above, the personal traits can include such aspects as cognitive traits, behavioral traits, and interest traits, and at 357, the personal, and more particularly the behavioral traits, can include such things as energy level, assertiveness, sociability, manageability, attitude, decisiveness, accommodations, independence, and objective judgment.

Referring now specifically to FIGS. 4A and 4B, the process 400 includes at 405 receiving into a computer processor data relating to a plurality of persons. The persons are employed in the same occupation. A portion of the persons includes top performers in the occupation, and a portion of the persons includes bottom performers in the occupation. The data relate to one or more of personal traits and performance traits. Personal traits can relate to such areas as cognitive traits, behavioral traits, and interests (470). More specifically, the behavioral personal traits can relate to such measures as a person's energy level, assertiveness, sociability, manageability, attitude, decisiveness, accommodating character, independence, and objective judgment (475). Performance traits can relate to such things as a sales quota, an error rate, a production level, and customer complaints involving the person (480). Interest traits quite simply relate to what a person is interested in (music, sports, art, theatre, cinema, travel, etc.).

At 410, the data relating to the plurality of persons are input into a software-based neural network. At 415, the neural network generates models for the personal traits as a function of the personal traits and the performance traits of the top performers. An example of such a model 600 for the personal trait of decisiveness is illustrated in FIG. 6. Specifically, the neural network derives the model 600, based on the personal traits and performance traits of the plurality of persons, and in particular the top performers of the plurality of persons, by analyzing responses to questions relating to decisiveness from the top performers. As can be seen in FIG. 6, the neural network has identified that top performers in the pertinent occupation range from a score of 4 to 7 for the personal trait of decisiveness. That is, the model for decisiveness is the 4-7 range.

At 420, the neural network generates a performance model. The performance model is made up of a number of models for the personal traits. An example of a performance model 700 is illustrated in FIG. 7. As can be seen in FIG. 7, the performance model 700 includes nine personal trait models 735 - - - energy level, assertiveness, sociability, manageability, attitude, decisiveness, accommodating character, independence, and objective judgment. Each personal trait model is identified by a particular range, such as the energy level model is identified by the range of 5-7, as indicated by the right leaning slash marks over those range numbers. In this manner, at 425, the neural network configures the performance model to determine whether a particular person, who is not currently in a particular job or a particular occupation, will likely be a top performer in that particular occupation, a bottom performer in that particular occupation, or neither a top performer nor a bottom performer in that particular occupation.

At 430, data relating to the particular person who is not currently in a particular job or occupation are received. These data relate to the personal traits of that particular person. At 435, the data relating to the particular person are compared to the performance model 700. At 440, an assessment is generated relating to whether the particular person is likely to be rated as a top performer, a bottom performer, or neither a top performer nor a bottom performer.

At 445, the data relating to the particular person and the data relating to the plurality of persons are obtained from answers provided by the particular person and the plurality of persons to a set of questions related to the personal traits of the particular person and the plurality of persons. In an embodiment, these questions are independent of the models, the performance model, and the occupation. At 450, a display that includes data relating to the assessment of the particular person is generated on an output device. These displays include many different forms.

For example, the display can be the performance model 700, and the performance model can indicate how, for each personal trait, the particular person compares to the models generated by the neural network (using the personal trait data of the top performers in the pertinent occupation). The performance model 700 in FIG. 7 further shows that for this particular person, Charlie Smith, his overall job match 705 for the occupation of a bank teller is 82%. That is, there is an 82% chance that Charlie Smith will be a top performer or successful candidate as a bank teller. In an embodiment, this job match percentage is determined by calculating the percentage of personal trait character model ranges into which the candidate falls. In another embodiment, different portions of the range such as lower, middle, or upper are weighted more heavily than other portions of the model range. Similarly, Mr. Smith's thinking (cognitive) style 710, behavioral traits 715, and interests 720 fall into the models generated using the personal traits of the top performers 88%, 83%, and 68% of the time respectively. FIG. 7 further illustrates Mr. Smith's match versus other candidates in the bar graph at 725. As the bar graph 725 shows, this candidate's job match was 82% as compared with matching percentages of other candidates. The bar graph 725 further shows that the most common job match percentage for this example was 76%. FIG. 7 further illustrates how a particular person compares with each of the personal trait models 735, generated by the neural network using the personal trait data of the top and bottom performers. For example, in FIG. 7, Mr. Smith fell outside the range for energy level, sociability, attitude, decisiveness, and accommodating character, as indicated by the left leaning slashes in the pertinent boxes within each model (4 for energy level, 4 for sociability, 2 for attitude, 3 for decisiveness, and 2 for accommodating character). FIG. 7 further illustrates that Mr. Smith fell within the range for assertiveness, manageability, accommodating character, independence, and objective judgment, as indicated by the cross-hatched lines in the pertinent boxes within each model (3 for assertiveness, 4 for manageability, 7 for independence, and 3 for objective judgment). The displayed output can further indicate a particular person's rankings related to a plurality of occupations as illustrated in FIG. 8, and a comparison of several different persons regarding job match percentages, cognitive traits, interests, and behavioral traits for a particular occupation, such as a bank teller as illustrated in FIG. 9.

As further indicated in the performance model of FIG. 7, the neural network generates a range relating to a particular personal trait, such as from 1-10 for the personal traits 735 in FIG. 7. Then, based upon the personal trait data relating to the top performers, the neural network generates a sub-range within this range. The sub-range serves as the actual model. As noted in this example, the sub-range and the range are a numeric scale. In another embodiment, as indicated at 455, the neural network can determine the breadth of a particular model. In FIG. 7, the neural network has determined that the breadth of the assertiveness personal trait is three, while the breadth of the independence personal trait is four. Similarly, at 760, the neural network can assign a weight to be applied to each of the personal traits in the model. Once again, the neural network determines the breadth of each personal trait model and the weight to assign to each personal trait model based on the data of the bottom and top performers for this occupation.

At 460, the neural network generates a plurality of performance models. These performance models include one or more different traits models for the traits models that make up the performance models. The plurality of performance models makes it less likely that an outlier candidate will be missed. For example, FIG. 7A illustrates another performance model 750. The performance model 750 was generated by the neural network using the data relating to the top and bottom performers, just like the performance model 700 of FIG. 7 was generated. The neural network determined that the data for the top and bottom performers indicate that top bank tellers display an assertiveness ranking of 3-5 and 7-9, and an independence ranking of 1-3 and 6-9. Consequently, the neural network generated a performance model 700 to identify potential top bank tellers, wherein the assertiveness and independence rankings are 3-5 and 6-9 respectively, and a performance model 750 to identify top bank tellers, wherein the assertiveness and independence rankings are 7-9 and 1-3 respectively. In another embodiment, instead of generating two separate (but related) performance models as illustrated in FIGS. 7 and 7A, the different rankings or ranges for a particular personal trait could be part of the particular personal trait model of a single performance model.

It is noted that the use of different sub-ranges or rankings for a particular trait among two or more performance models to identify outlier candidates is not just simply permitting a different range or ranking to be acceptable (for a particular personal trait). That is, it is not just permitting two or more ranges of a particular trait to be present in a single performance model. Rather, the different ranges for the particular trait should be in separate performance models since a first range of a trait may only have legitimacy in association with particular ranges of other traits, and a second range of that same trait may only have legitimacy in association with different particular ranges of other traits. By tying the two ranges of the trait to one or more other personal traits, there is a relatively narrow area on each model that establishes a “sweet spot” for an outlier candidate. That is, the selectivity of the system can be enhanced by establishing another model that is focused on a completely different set of criteria giving an equally strong candidate for a particular job or employment position. These ties or associations of traits are determined by the neural network. In some circumstances at least, if the multiple rankings were in the same performance model, such a system could actually reduce the selectivity and effectiveness of the system. Stated another way, a different ranking, range, or score on a personal trait model that may include an outlier should be associated with the ranges of other personal trait models in each performance model (as indicated above in connection with the assertiveness and independence traits). For example, for a particular occupation, the neural network may determine that a person can be successful if they are either independent (6-9) or not independent (1-3). However, such independent models are only legitimate when they are correctly correlated with the particular other trait models of the particular performance model. That is, for example, a particular range for assertiveness must hold true for the independent model of (6-9), and a different range for assertiveness must hold true for the other independent range of (1-3). Consequently, two or more performance models are best used. As noted above, by generating multiple performance models for the different independence ranges, it is less likely that outlier candidates will be missed. If the system was limited to only one of the ranges for the particular trait, candidates who fall into the other independence range would be missed (even though the neural network would indicate that a particular performance model generated with that range could identify potential successful candidates).

At 465, the neural network nulls out a particular model and determines the effect of the nulling out on other models, the performance model, and the selection of potential candidates.

FIGS. 5A and 5B illustrate another example embodiment of a process 500 that uses a neural network to select employees for a particular job or occupation. At 505, data are received relating to personal traits and occupational performance traits of a plurality of persons who are employed in the same occupation. At 510, the persons are divided into two groups. The two groups are made up of a first group of top performers in the occupation and a second group of bottom performers in the occupation. The division into the two groups is based on the occupational performance traits of the plurality of persons. At 515, the data relating to the personal traits and the occupational performance traits of the two groups are input into a software-based neural network. At 520, the neural network generates models for the personal traits as a function of the personal traits and the performance traits of the two groups, and at 530, the neural network generates a performance model comprising the models. At 533, it is noted that the data relating to the personal traits of the two groups are derived from a set of questions. The set of questions is independent of the models, the performance model, and the occupation. In an embodiment, the set of questions is developed by an industrial psychologist, and in another embodiment the questions are developed before the generation of any models and/or performance models.

After the generation of the performance model, the following steps are executed. At 535, data are collected from a particular person using the set of questions. At 540, the data from the particular person are input into the performance model, and at 545, the performance model identifies the particular person as a potential top performer or a potential bottom performer in the occupation.

At 550, it is noted that the particular person is not one of the plurality of persons. At 552, the plurality of persons and the particular person are employed by a business organization, at 554, the plurality of persons is employed by a business organization and the particular person is not employed by the business organization, and at 556, the business organization is a single business organization.

At 558, a display is generated on an output device. The display includes data relating to the assessment of the particular person. The display can include a ranking relating to the particular person and the occupation, a ranking relating to the particular person and cognitive traits for the occupation, a ranking relating to the particular person and interests for the occupation, and a ranking relating to the particular person and behavioral traits for the occupation.

At 560, the models for the personal traits comprise a sub-range within a range, and the sub-range and the range comprise a numeric scale. At 565, the neural network determines a breadth of a particular model, and the neural network determines a weight to be accorded to a particular model.

At 570, the neural network generates a plurality of performance models. In this plurality of performance models, each performance model is configured to identify the particular person as a potential top performer. As noted above, a plurality of performance models can be used to assist in capturing any outliers in the group. At 575, the neural network nulls out a particular model. The neural network can then determine the effect the nulling out of the particular model has on the other models, the performance model, and the selection of a particular candidate. At 580, the performance traits include a sales quota, an error rate, a production level, and/or a level of customer complaints. At 585, the personal traits include cognitive traits, behavioral traits, and/or interests. At 590, the personal traits include energy level, assertiveness, sociability, manageability, attitude, decisiveness, accommodating character, independence, and objective judgment.

FIG. 10 is an overview diagram of hardware and an operating environment in conjunction with which embodiments of the invention may be practiced. The description of FIG. 10 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by 110 remote processing devices that are linked through a communications network. In a distributed computing environment, program modules may be located in both local and remote memory storage devices.

In the embodiment shown in FIG. 10, a hardware and operating environment is provided that is applicable to any of the servers and/or remote clients shown in the other Figures.

As shown in FIG. 10, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 10 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1-22. (canceled)

23. A system comprising:
a computer processor operable to:
maintain in a computer storage device a database of job performance data for a plurality of persons employed in a plurality of occupations;
maintain in the database assessment data for the plurality of persons, the assessment data comprising cognitive assessment data, behavior assessment data, and interest assessment data;
identify top performers in each of the plurality of occupations as a function of the job performance data;
receive into the computer processor for an individual person cognitive assessment data, behavior assessment data, and interest assessment data;
compare the cognitive assessment data, behavior assessment data, and interest assessment data for the individual person with the cognitive assessment data, behavior assessment data, and interest assessment data for the top performers in each of the plurality of occupations; and
recommend one or more of the plurality of occupations to the individual person as a function of the comparison of the cognitive assessment data, behavior assessment data, and interest assessment data of the individual person with the cognitive assessment data, behavior assessment data, and interest assessment data of the top performers in each of the plurality of occupations, such that the individual person is more likely to succeed in the one or more recommended occupations.

24. The system of claim 23, wherein the cognitive assessment data, behavior assessment data, and interest assessment data of the plurality of persons are determined from responses by the plurality of persons to assessment questions.

25. The system of claim 23, wherein the cognitive assessment data, behavior assessment data, and interest assessment data of the individual person are determined from responses by the individual person to assessment questions.

26. The system of claim 23, wherein the cognitive assessment data, behavior assessment data, and interest assessment data for the plurality of persons are collected over a period of years.

27. The system of claim 23, wherein the computer processor is operable to add a new occupation to the plurality of occupations and receive and maintain cognitive assessment data, behavior assessment data, and interest assessment data for persons employed in the new occupation; and to identify top performers in the new occupation.

28. The system of claim 23, wherein the recommendation of the one or more of the plurality of occupations comprises a ranked list of occupations ranging from occupations that are most suited to the individual person to occupations that are least suited to the individual person.

29. The system of claim 23, wherein the computer processor is operable to receive data relating to the individual person comprising education level completed, additional education planned, and an indicated interest in one or more occupations by the individual person, and to use the data relating to educational level completed, additional education planned, and the indicated interest in one or more occupations in making the recommendation of the one or more occupations of the plurality of persons to the individual person.

30. A system comprising:
one or more computer processors configured for:
receiving data relating to a plurality of persons in a plurality of occupations, a portion of the plurality of persons comprising top performers in the occupations, wherein the data relates to one or more of cognitive traits, behavioral traits, interest traits, and performance traits;
inputting the data into a software-based neural network;
using the neural network to generate models, for each of the occupations, for one or more of the cognitive traits, behavioral traits, and interest traits as a function of one or more of the cognitive traits, behavioral traits, interest traits, and performance traits of the top performers; and
using the neural network to generate a performance model for each of the plurality of occupations, the performance model for each of the plurality of occupations comprising one or more of the behavioral traits models, the cognitive traits models, and the interest traits models;
wherein the performance models are configured to determine that a particular person, who is not one of the plurality of persons, will likely be a top performer in one or more of the plurality of occupations.

31. The system of claim 30, comprising using the performance models for the plurality of occupations to identify the particular person as a potential top performer.

32. The system of claim 30, comprising one or more computer processors configured for:
receiving data relating to the particular person, wherein the data relates to one or more of the behavioral traits, the cognitive traits, and the interest traits;
comparing the data relating to the particular person to the performance models of each of the plurality of occupations; and
generating an assessment of whether the particular person is likely to be rated as a top performer in each of the plurality of occupations.

33. The system of claim 30, wherein the data relating to the particular person and the data relating to the plurality of persons in the plurality of occupations are obtained from answers provided by the particular person and the plurality of persons in the plurality of occupations to a set of questions that are independent of the models, the performance model, and the occupation.

34. The system of claim 30, comprising one or more computer processors for generating a display on an output device, the display including data relating to the assessment of the particular person.

35. The system of claim 34, wherein the display comprises one or more of a ranking of the plurality of occupations for which the particular person is most suited, a ranking relating to the particular person and cognitive traits for each of the plurality of occupations, a ranking relating to the particular person and interests for each of the plurality of occupations, and a ranking relating to the particular person and behavioral traits for each of the plurality of occupations.

36. The system of claim 30, wherein the models comprise a numeric range.

37. The system of claim 36, wherein the neural network generates for each of the plurality of occupations at least one behavioral traits model, cognitive traits model, or interest traits model comprising two or more numeric sub-ranges within the numeric range of the at least one personal traits model, cognitive traits model, or interest traits model such that the system is less likely to treat the particular person as an outlier candidate.

38. The system of claim 30, comprising using the neural network to determine a breadth of a particular model.

39. The system of claim 30, comprising using the neural network to determine a weight to be accorded to a particular model.

40. The system of claim 30, comprising using the neural network to generate a plurality of performance models for each of the plurality of occupations, each performance model configured to identify the particular person as a potential top performer in the occupation.

41. The system of claim 30, comprising using the neural network to null out a particular model and to determine the effect of the nulling out on other models.

42. The system of claim 30, wherein the performance traits comprise one or more of a sales quota, an error rate, a production level, and a level of customer complaints.

43. The system of claim 30, wherein the behavioral traits comprise one of more of energy level, assertiveness, sociability, manageability, attitude, decisiveness, accommodations, independence, and objective judgment.

44. The system of claim 30, wherein the plurality of persons and plurality of occupations are associated with a plurality of business organizations.
